(19) United States
(12) Patent Application Publication
(10) Pub. No.: US 2022/0279368 A1
(43) Pub. Date: Sep. 1, 2022

(54) LINE TEST SYSTEM AND LINE TEST METHOD

(71) Applicant: Nippon Telegraph and Telephone Corporation, Tokyo (JP)

(72) Inventors: Yu ONO, Musashino-shi, Tokyo (JP); Tomohiro TOKUYASU, Musashino-shi, Tokyo (JP); Hiroyuki FURUYA, Musashino-shi, Tokyo (JP); Hayato FUKUZONO, Musashino-shi, Tokyo (JP); Tsutomu TATSUTA, Musashino-shi, Tokyo (JP); Tomohiro NAKAYAMA, Osaka-shi, Osaka (JP)

(21) Appl. No.: 17/624,898

(22) PCT Filed: Jun. 26, 2020
(86) PCT No.: PCT/JP2020/025311

§ 371 Date: Jan. 5, 2022

(30) Foreign Application Priority Data
Jul. 5, 2019 (JP) 2019-125981

(51) Int. Cl. H04W 24/08; H04W 24/10; H04M 3/26

(52) U.S. Cl. CPC H04W 24/08; H04W 24/10; H04M 3/26; H04W 84/14

(57) ABSTRACT

A wireless base station device includes a test request unit that, upon receipt of a line test request from a host station side, transmits an implementation request for a line test to a wireless terminal station device and a test response unit that transmits at least one of a terminal identification code returned from the wireless terminal station device and a terminal identification code and a line test result of the wireless base station device to the host station side. A wireless terminal station device includes a test implementation unit that receives the implementation request for the line test from the wireless base station device, executes the line test between the wireless terminal station device and the subscriber home, and acquires the line test result and a test-signal communication unit that transmits at least one of a terminal identification code returned from a device on the subscriber home side and a terminal identification code and a line test result of the wireless terminal station device to the wireless base station device.

### TECHNICAL FIELD

The present invention relates to a line test system having a function of performing a line test remotely from an existing test desk in a telephone line including a wireless section and a line test method.

### BACKGROUND ART

It has been a common practice in a metal line forming a telephone line to perform a line test by remotely operating, from a test desk, a protector in a subscriber home provided with a relay circuit. However, when a wireless section is present in the telephone line, a problem is that it is difficult to remotely operate a relay circuit of the protector from the test desk to form a loop.

In a method of forming a loop in a protector and performing a loop-back test, it is necessary to isolate network equipment and customer premise equipment with a current protector (for example, “a No. 6 subscriber protection with a remote isolation function”) in remote operation from a test desk. To this end, it is possible to verify conduction by performing, with a polarity inversion signal (110 V) from the test desk, isolation of a station line side and a terminal device side in a subscriber home with a relay circuit and sending a terminal identification code from the protector to the test desk. Further, it is possible to obtain a line test result such as a resistance value and capacitance of a line by forming a loop in the protector. When the test ends, a switch-back signal is sent from the test desk to the protector to connect the station line and a terminal line in the subscriber home. In this way, in the related art, it is possible to remotely form the loop from the test desk and perform the line test in the protector between the terminal device in the subscriber home and the line on the station side. For example, a method of remotely performing a line test from a test desk using a protector for a subscriber home provided with a relay circuit is described (see, for example, Patent Literature 1).

### CITATION LIST

### Patent Literature

Patent Literature 1: Japanese Patent Laid-Open No. H5-160902

### SUMMARY OF THE INVENTION

### Technical Problem

However, in the case of a telephone line including a wireless section, a problem is that it is difficult to remotely implement a line test (a conduction test, a loop-back test, or the like) from the test desk and it takes time to identify a failed section.

An object of the present invention is to provide a line test system and a line test method that can implement, in a telephone line including a wireless section, a line test from a remote place with the same method as a method for a conventional telephone line not including a wireless section and can easily identify a failed section.

### Means for Solving the Problem

A line test system of a first invention is a line test system that performs a test of a telephone line that includes a wireless section formed by a wireless base station device and a wireless terminal station device and connects a host station and a subscriber home, the wireless base station device including: a test request unit that, upon receipt of a line test request from the host station side, transmits an implementation request for a line test to the wireless terminal station device; and a test response unit that transmits at least one of a terminal identification code returned from the wireless terminal station device and a terminal identification code and a line test result of the wireless base station device to the host station side, the wireless terminal station device including: a test implementation unit that receives the implementation request for the line test from the wireless base station device, executes the line test between the wireless terminal station device and the subscriber home, and acquires the line test result; and a test-signal communication unit that transmits at least one of a terminal identification code returned from a device on the subscriber home side and a terminal identification code and a line test result of the wireless terminal station device to the wireless base station device.

A line test method of a second invention is a line test method for performing a test of a telephone line that includes a wireless section formed by a wireless base station device and a wireless terminal station device and connects a host station and a subscriber home, the wireless base station device executing: test request processing for, upon receipt of a line test request from the host station side, transmitting an implementation request for a line test to the wireless terminal station device; and test response processing for transmitting at least one of a terminal identification code returned from the wireless terminal station device and a terminal identification code and a line test result of the wireless base station device to the host station side, the wireless terminal station device executing: test implementation processing for receiving the implementation request for the line test from the wireless base station device, executing the line test between the wireless terminal station device and the subscriber home, and acquiring the line test result; and test-signal communication processing for transmitting at least one of a terminal identification code returned from a device on the subscriber home side and a terminal identification code and a line test result of the wireless terminal station device to the wireless base station device.

### Effects of the Invention

The line test system and the line test method according to the present invention can implement, in a telephone line including a wireless section, a line test from a remote place with the same method as a method for a conventional telephone line not including a wireless section and can easily identify a failed section.

### BRIEF DESCRIPTION OF DRAWINGS

FIG. 1 is a diagram showing an example of a line test system according to an embodiment.

FIG. 2 is a diagram showing an example of a problem in the case in which a wireless section is provided in a line test system in a comparative example without a wireless section.

FIG. 3 is a diagram showing a line test sequence in the line test system in the comparative example.

FIG. 4 is a diagram showing an example of a line test sequence of the line test system according to the embodiment.

FIG. 5 is a diagram showing a configuration example of a wireless base station and a wireless terminal station of the line test system according to the embodiment.

FIG. 6 is a diagram showing an example of a case in which a line is disconnected between an exchange office and the wireless base station.

FIG. 7 is a diagram showing an example of a case in which a line is disconnected in a wireless section between the wireless base station and the wireless terminal station.

FIG. 8 is a diagram showing an example of a case in which a line is disconnected between the wireless terminal station and a protector.

FIG. 9 is a diagram showing an example of a line test sequence of a line test system in an application example.

FIG. 10 is a diagram showing an example of a case in which the line is disconnected in the wireless section between the wireless base station and the wireless terminal station.

FIG. 11 is a diagram showing an example of a case in which a line between the wireless base station and the protector is disconnected.

FIG. 12 is a diagram showing a flow of processing for identifying, in a test desk, a failed section in the line test system according to the embodiment.

### DESCRIPTION OF EMBODIMENTS

An embodiment of a line test system and a line test method according to the present invention is explained below with reference to the drawings.

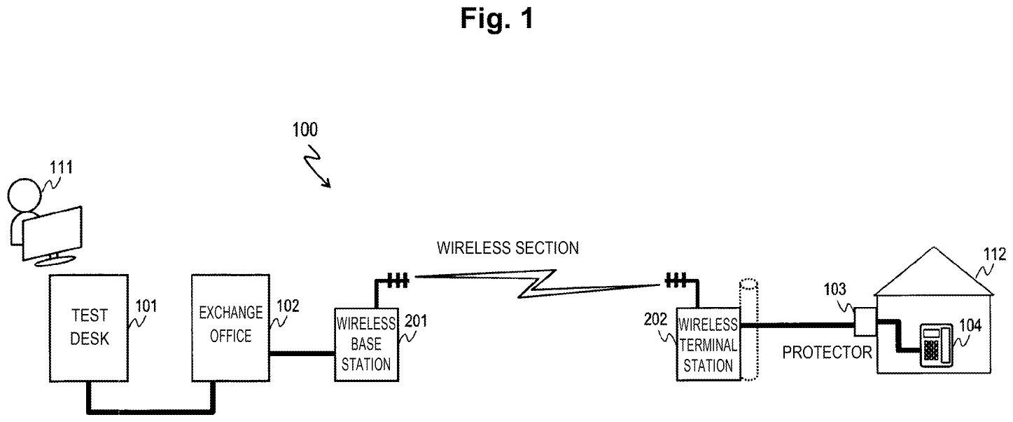

FIG. 1 shows an example of a line test system 100 according to this embodiment. In FIG. 1, the line test system 100 includes a test desk 101, an exchange office 102, a protector 103, a terminal station 104, a wireless base station 201, and a wireless terminal station 202. An operator 111 performing a line test can remotely operate the protector 103 from the test desk 101 via the exchange office 102, the wireless base station 201, and the wireless terminal station 202, temporarily form a loop of a telephone line in the protector 103 set at a demarcation point for connecting the telephone line to the terminal station 104 in a subscriber home 112, and perform the line test. The line test is a test for, for example, measuring a resistance value, capacitance, a voltage value, and the like of the telephone line and identifying presence or absence of disconnection of the telephone line and a failed section. Note that the wireless base station 201 and the wireless terminal station 202 are devices for performing wireless communication and respectively correspond to a wireless base station device and a wireless terminal station device. The exchange office 102 including the test desk 101 corresponds to a host station of the wireless base station 201.

The test desk 101 performs the line test in a sequence determined in advance by the operator 111 remotely operating the protector 103 and identifies a failed section based on a test result.

The exchange office 102 houses telephone lines between the exchange office 102 and terminal stations 104 of a plurality of subscriber homes 112 in a predetermined area and connects the telephone lines to a host line (not shown).

The protector 103 is a device for drawing the telephone line into the subscriber home 112. The protector 103 is provided with a fuse for preventing an overcurrent from flowing into the subscriber home 112 to break the terminal station 104, a relay circuit for looping a line before the subscriber home 112, a circuit for remotely operating the relay circuit from the test desk 101, and the like.

The terminal station 104 is a communication apparatus such as a telephone set in the subscriber home 112 and connected to the telephone line via the protector 103.

The wireless base station 201 and the wireless terminal station 202 form a wireless section in the telephone line between the exchange office 102 and the protector 103 of the subscriber home 112. In the example shown in FIG. 1, the wireless base station 201 is set on the exchange office 102 side and the wireless terminal station 202 is set on the subscriber home 112 side. The wireless base station 201 and the exchange office 102 may be present in the same station. The wireless base station 201 may project from the exchange office 102 to be set in another place.

In this way, even when the line test system 100 according to this embodiment includes the wireless section formed by the wireless base station 201 and the wireless terminal station 202 in the telephone line between the exchange office 102 and the subscriber home 112, as in the related art, the operator 111 can perform, from the test desk 101, the line test between the exchange office 102 and the protector 103 of the subscriber home 112 with remote operation.

[Line Test System in a Comparative Example]

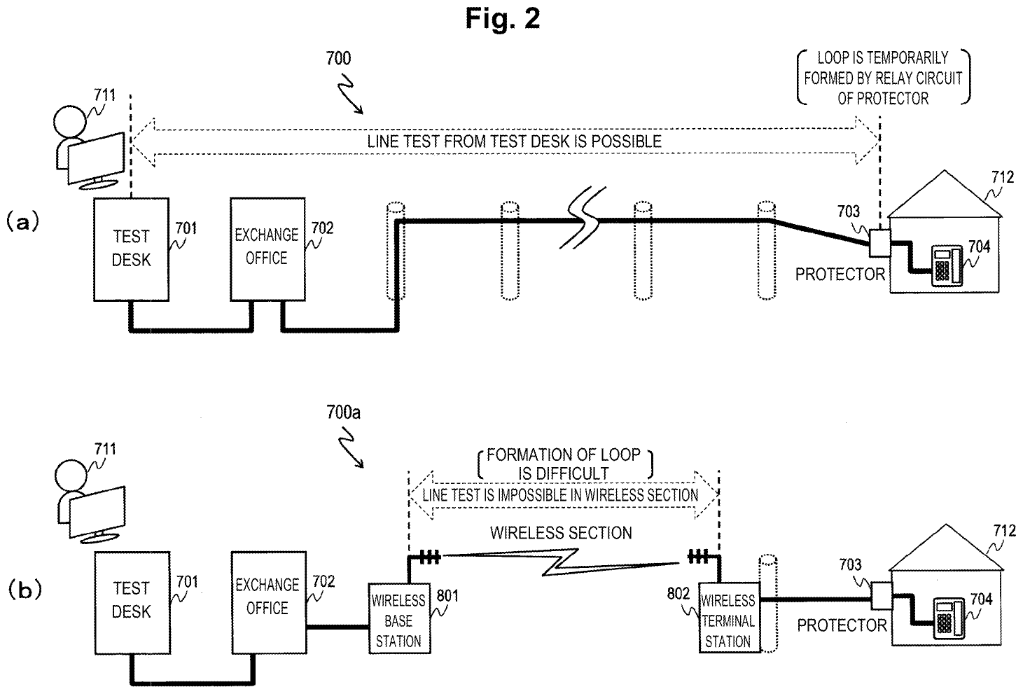

FIG. 2 shows an example of a problem in the case in which a wireless section is provided in a line test system 700 in a comparative example without a wireless section. In FIG. 2, (a) shows the line test system 700 in the comparative example that uses a metal line without a wireless section and (b) shows a line test system 700a obtained by providing a wireless section in the line test system 700 in the comparative example.

In (a) of FIG. 2, the line test system 700 includes a test desk 701, an exchange office 702, a protector 703, and a terminal station 704. An operator 711 performing a line test remotely operates the protector 703 from the test desk 701 via the exchange office 702, temporarily forms a loop of a telephone line in the protector 703 before the subscriber home 112, and performs the line test.

The test desk 701, the exchange office 702, the protector 703, and the terminal station 704 are respectively equivalent to the test desk 101, the exchange office 102, the protector 103, and the terminal station 104 in this embodiment explained with reference to FIG. 1. In the line test system 700 in the comparative example, all sections are connected by the metal line without a wireless section. When a wireless section is provided in such a line test system 700 in the comparative example, as in the line test system 700a shown in (b) of FIG. 2, a problem is that it is difficult to transmit, to the protector 703, a test request by polarity inversion output from the test desk 701 via the exchange office 702 between a wireless base station 801 and a wireless terminal station 802 and it is difficult to perform a line test between the wireless section and the wireless terminal station 802 and the protector 703.

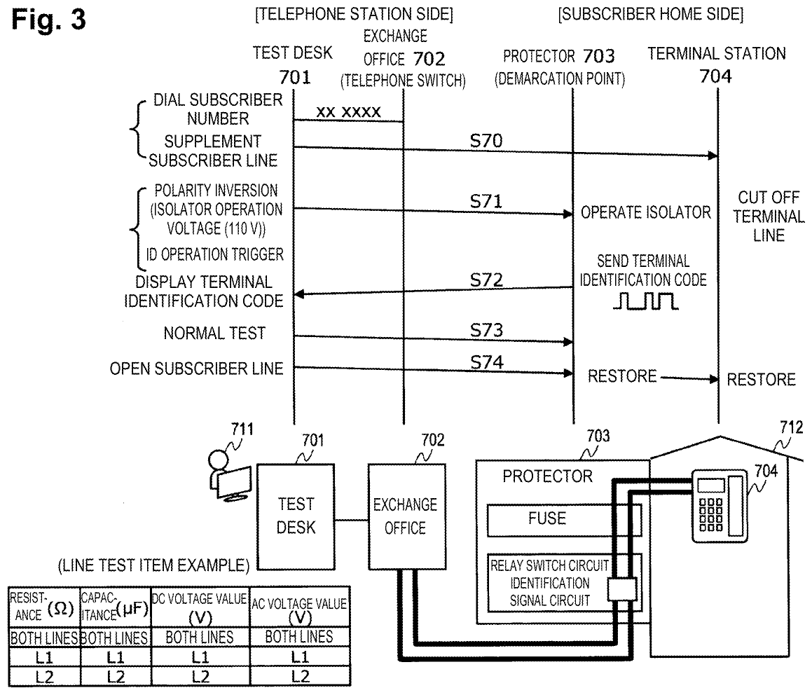

FIG. 3 shows a line test sequence in the line test system 700 in the comparative example. Note that the line test sequence shown in FIG. 3 is executed by the test desk 701, the exchange office 702, the protector 703, and the terminal station 704 shown in FIG. 2(a). Note that the protector 703 is provided with a fuse for preventing an overcurrent from flowing into the subscriber home 112 to break the terminal station 104, a relay switch circuit for looping a line before the subscriber home 112, a circuit for remotely operating a relay circuit from the test desk 101, an identification signal circuit for transmitting a terminal identification code to the exchange office 702, and the like.

First, the operator 711 of the test desk 701 dials a subscriber number of the terminal station 704 in order to implement a line test between the exchange office 702 and a subscriber home 712 where the terminal station 704 is present. The dialed subscribed number (xx-xxxx) is recognized by the exchange office 702, which is a telephone switch. The test desk 701 is connected to the terminal station 704 via the exchange office 702 and the protector 703 at a demarcation point. Supplementation of a subscriber line is completed (S70). The operator 711 performs polarity inversion of the metal line in order to operate an isolator of the protector 703 and loop the line (S71). Consequently, the isolator of the protector 703 operates, cuts off the terminal line to the terminal station 704, and forms a loop of the metal line from the exchange office 702. Note that the polarity inversion is performed at an operating voltage 110 V of the isolator and functions as an ID operation trigger for causing the identification signal circuit of the protector 703 to send a terminal identification code. The protector 703, in which the isolator operates, sends the terminal identification code to the test desk 701. The terminal identification code is displayed on the test desk 701 (S72). The operator 711 verifies the terminal identification code displayed on the test desk 701, determines that the loop formation of the telephone line in the protector 703 is completed, and test preparation is arranged, and performs a normal line test of predetermined test items (S73). When a line test result is acquired and the line test ends, the operator 711 of the test desk 701 opens the subscriber line to the subscriber home 712. The loop of the protector 703 is released. The line from the protector 703 to the terminal station 704 in the subscriber home 712 is restored (S74).

As the items of the line test performed in step S73, as shown in (line test item example) in FIG. 3, resistance (Ω), capacitance (μF), a DC voltage value (V), an AC voltage value (V), and the like are measured about the metal line (a pair line of L1 and L2). Note that these test items are respectively implemented between both the lines L1 and L2 and for the L1 line and the L2 line.

However, in the case of the line test system 700a in the comparative example explained with reference to (b) of FIG. 2, the wireless section formed by the wireless base station 801 and the wireless terminal station 802 is present between the exchange office 702 and the protector 703 shown in FIG. 3. Therefore, a problem is that, since the polarity inversion and the test request output from the test desk 701 and the exchange office 702 are not sent to the protector 703 and the formation of the line loop is difficult, the line test cannot be performed.

Accordingly, the wireless base station 201 and the wireless terminal station 202 according to this embodiment explained with reference to FIG. 1 have a function of solving the problem of the line test system 700a in the comparative example and enabling the line test to be performed between the exchange office 102 and the protector 103.

Subsequently, functions of the wireless base station 201 and the wireless terminal station 202 according to this embodiment are explained.

(1) Functions of the Wireless Base Station 201

The wireless base station 201 according to this embodiment has functions described below.

A function of detecting polarity inversion of the exchange office 102 and transmitting an implementation request for a line test to the wireless terminal station 202

A function of transmitting a terminal identification code (wireless base station) to the exchange office 102 when both of a line test result and a terminal identification code (wireless terminal station) cannot be received from the wireless terminal station 202 (the wireless section is disconnected): With this function, it is possible to notify the exchange office 102 side that the line in the wireless section between the wireless base station 201 and the wireless terminal station 202 is disconnected.

(2) Functions of the Wireless Terminal Station 202
(a) The wireless terminal station 202 itself according to this embodiment has functions described below.

A function of performing polarity inversion of the line in an analog port on the protector 103 side: With this function, the wireless terminal station 202 causes the protector 103 to execute cut-off of the terminal line connected to the terminal station 104 of the subscriber home 112 from the protector 103 and the formation of the loop of the line input to the protector 103 from the wireless terminal station 202.

A function of receiving the terminal identification code from the protector 103: With this function, it is possible to verify conduction of a line between the wireless terminal station 202 and the protector 103. If a terminal identification code (protector) is not received from the protector 103 even if the wireless terminal station 202 executes the polarity inversion, it is seen that the line between the wireless terminal station 202 and the protector 103 is disconnected. In the following explanation, the terminal identification code of the protector 103 is referred to as terminal identification code (protector). Similarly, the terminal identification code of the wireless base station 201 is referred to as terminal identification code (wireless base station) and the terminal identification code of the wireless terminal station 202 is referred to as terminal identification code (wireless terminal station).

A function of, for example, implementing a line test between the wireless terminal station 202 and the protector 103 and retaining a line test result: With this function, a loop-back test (line resistance, capacitance, and the like) in the protector 103, which loops the line, is performed and a line test result is retained.

(b) The wireless terminal station 202 according to this embodiment executes functions described below between the wireless terminal station 202 and the wireless base station 201.

A function of receiving an implementation request for a line test from the wireless base station 201 and implementing the line test of (a), a function of transmitting a line test result (the terminal identification code (protector) of the protector 103 and measurement values of predetermined line test items) to the wireless base station 201, and a function of transmitting the terminal identification code (wireless terminal station) to the wireless base station 201 when a line between the wireless terminal station 202 and the protector 103 is disconnected and measurement is impossible: With this function, it is possible to notify the wireless base station 201 side that the line between the wireless terminal station 202 and the protector 103 is disconnected.

[A Method of Identifying a Failed Section on the Test Desk 101 Side]

According to responses from the exchange office 102, the wireless base station 201, the wireless terminal station 202, and the protector 103, when a line test result is not displayed on the test desk 101, the operator 111 of the test desk 101 can identify a failed section as explained below.

When both of the terminal identification codes are not displayed, line disconnection has occurred between the exchange office 102 and the wireless base station 201

When the terminal identification code (wireless base station) is displayed, line disconnection has occurred in the wireless section between the wireless base station 201 and the wireless terminal station 202

When the terminal identification code (wireless terminal station) is displayed, line disconnection has occurred between the wireless terminal station 202 and the protector 103

Note that, when the terminal identification code (protector) is displayed on the test desk 101, it is indicated that the line test has normally ended and a line test result is also displayed on the test desk 101.

In this way, even when the line test system 100 according to this embodiment includes the wireless section formed by the wireless base station 201 and the wireless terminal station 202 in the telephone line between the exchange office 102 and the subscriber home 112, as in the related art, the operator 111 can perform, from the test desk 101, a line test between the exchange office 102 and the protector 103 of the subscriber home 112 with remote operation.

[Example of a Line Test Sequence]

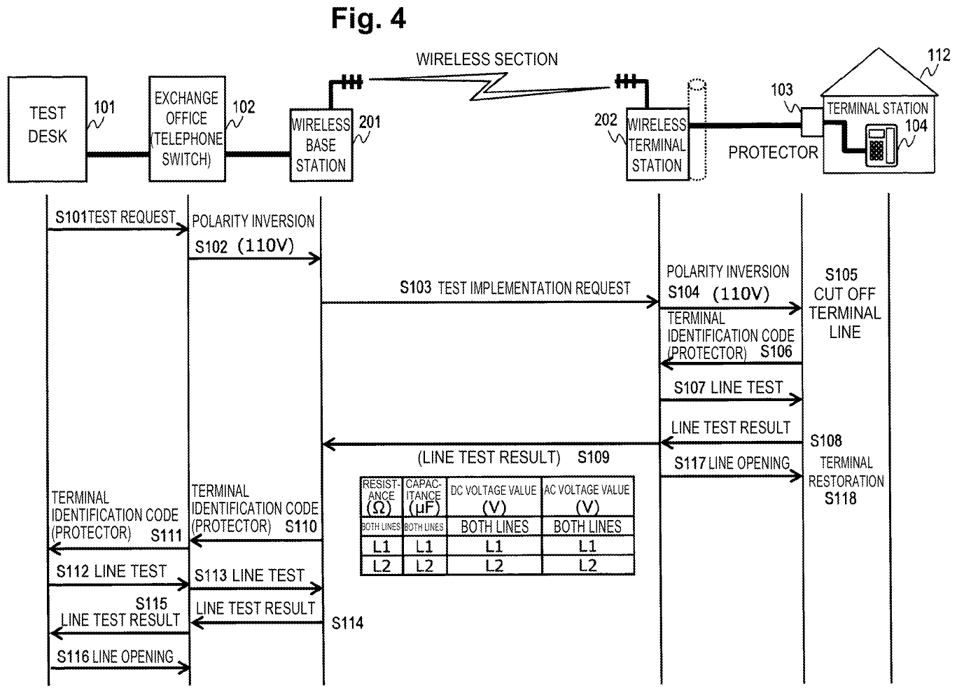

FIG. 4 shows an example of a line test sequence of the line test system 100 according to this embodiment. Note that kinds of processing shown in FIG. 4 are executed by the line test system 100 including the test desk 101 operated by the operator 111, the exchange office 102, the wireless base station 201, the wireless terminal station 202, the protector 103, and the terminal station 104 of the subscriber home 112 explained with reference to FIG. 1.

In step S101, the operator 111 outputs a test request for the telephone line from the test desk 101 to the exchange office 102 (a line test request).

In step S102, the exchange office 102 receives the test request from the test desk 101 and inverts the polarity of a voltage of 110 V applied to the line.

In step S103, upon detection of the inversion of the polarity of the line input from the exchange office 102 and receipt of a test implementation request from the test desk 101, the wireless base station 201 transmits an implementation request for a line test to the wireless terminal station 202.

In step S104, the wireless terminal station 202 inverts, based on a test start request received from the wireless base station 201, the polarity of the voltage of 110 V applied to a line connected to the protector 103.

In step S105, the protector 103 detects that the polarity of the line connected to the wireless terminal station 202 is inverted, opens and closes the relay circuit on the inside, and cuts off a terminal line connected to the terminal station 104 of the subscriber home 112.

In step S106, the protector 103 outputs the terminal identification code (protector) of the protector 103 to the wireless terminal station 202. Note that the wireless terminal station 202 temporarily retains the terminal identification code (protector).

In step S107, the wireless terminal station 202 receives the terminal identification code (protector) from the protector 103 to thereby recognize that the terminal line is cut off and the test preparation is arranged, and performs a line test between the wireless terminal station 202 and the protector 103. Note that line test items are the same as the items explained in the comparative example shown in FIG. 3.

In step S108, the wireless terminal station 202 acquires a line test result between the wireless terminal station 202 and the protector 103. Note that the wireless terminal station 202 temporarily retains the acquired line test result.

In step S109, the wireless terminal station 202 transmits the retained line test result to the wireless base station 201. At this time, the line test result transmitted by the wireless terminal station 202 includes the terminal identification code (protector) received from the protector 103 and retained.

In step S110, the wireless base station 201 outputs the terminal identification code (protector) included in the line test result received from the wireless terminal station 202 to the exchange office 102.

In step S111, the exchange office 102 outputs the terminal identification code (protector) input from the wireless base station 201 to the test desk 101. The terminal identification code (protector) is displayed on the test desk 101.

In step S112, the operator 111 verifying the terminal identification code (protector) performs the same line test as the line test in step S73 in the comparative example shown in FIG. 3.

In step S113, the exchange office 102 performs the line test as in step S112.

In step S114, in response to the line test in step S113, the wireless base station 201 outputs the line test result received from the wireless terminal station 202 and retained to the exchange office 102. The line test result output to the exchange office 102 is the line test result between the wireless terminal station 202 and the protector 103 acquired in step S109.

In step S115, the exchange office 102 outputs the line test result between the wireless terminal station 202 and the protector 103 input from the wireless base station 201 to the test desk 101. The line test result is displayed on a screen of the test desk 101. When the line test result is not displayed, the operator 111 of the test desk 101 identifies, based on the method of identifying a failed section on the test desk 101 side explained above, a failed section from the terminal identification code displayed on the test desk 101.

In step S116, the operator 111 verifying the line test result displayed on the test desk 101 instructs the exchange office 102 to perform line opening. Note that, actually, the line opening is executed in the next step at a point in time when the wireless terminal station 202 acquires the line test result in step S108.

In step S117, the wireless terminal station 202 transmits the line test result input from the protector 103 in step S109 to the wireless base station 201 and, thereafter, instructs the protector 103 to perform line opening.

In step S118, when the line opening is instructed from the wireless terminal station 202, the protector 103 switches back the terminal line cut off by the relay circuit in step S105 and connects the line from the wireless terminal station 202 to the terminal station 104 of the subscriber home 112. Terminal restoration is completed.

In this way, simply by performing the same operation as the operation performed when the line test is performed in the line test system 700 in the comparative example, the operator 111 of the test desk 101 can perform the line test even when the line test system 100 includes the wireless section between the exchange office 102 and the protector 103.

[Configuration Example of the Line Test System 100]

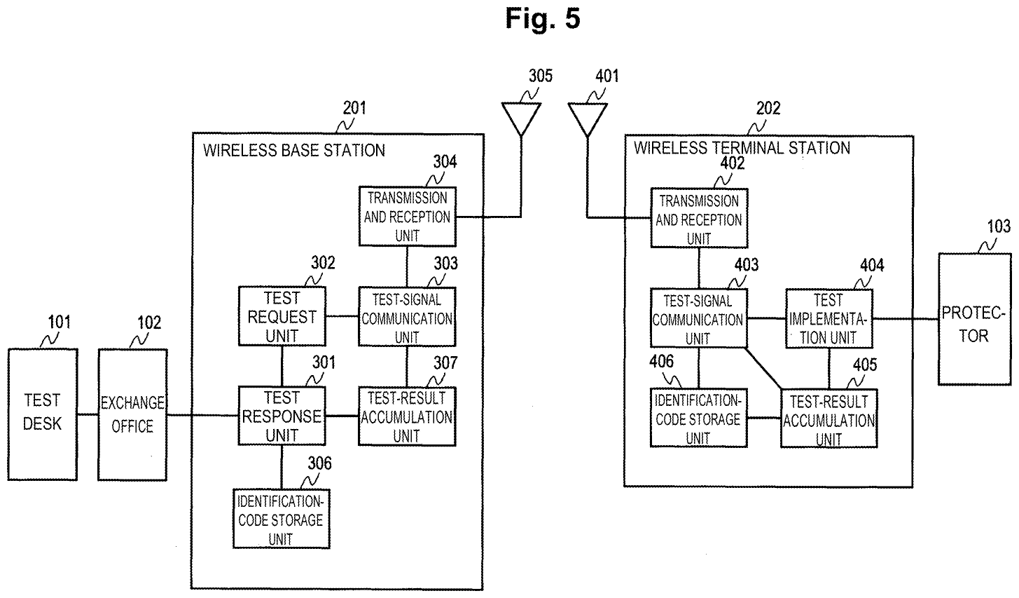

FIG. 5 shows a configuration example of the wireless base station 201 and the wireless terminal station 202 of the line test system 100 according to this embodiment. In FIG. 5, the wireless base station 201 includes a test response unit 301, a test request unit 302, a test-signal communication unit 303, a transmission and reception unit 304, an antenna 305, and an identification-code storage unit 306. In FIG. 5, the wireless terminal station 202 includes an antenna 401, a transmission and reception unit 402, a test-signal communication unit 403, a test implementation unit 404, a test-result accumulation unit 405, and an identification-code storage unit 406.

First, the units of the wireless base station 201 are explained.

The test response unit 301 detects presence or absence of polarity inversion of the line connected to the exchange office 102 and outputs a terminal identification code and a line test result of the protector 103, the wireless terminal station 202, or the wireless base station 201 to the exchange office 102 and the test desk 101. Note that processing performed by the test response unit 301 corresponds to the test response processing.

The test response unit 301 receives a test request from the test desk 101 (polarity inversion of the line connected to the exchange office 102) and the test request unit 302 outputs a test implementation request to the wireless terminal station 202. Note that processing performed by the test request unit 302 corresponds to the test request processing.

The test-signal communication unit 303 transmits, based on the test implementation request output by the test request unit 302, a test signal to the wireless terminal station 202 via the transmission and reception unit 304. The test-signal communication unit 303 accumulates a line test result received from the wireless terminal station 202 in a test-result accumulation unit 307.

The transmission and reception unit 304 has a function of transmitting and receiving signals to and from the wireless terminal station 202 via the antenna 305.

The antenna 305 converts a signal output by the transmission and reception unit 304 into a radio wave and transmits the radio wave to the wireless terminal station 202 and converts a radio wave received from the wireless terminal station 202 into a signal and outputs the signal to the transmission and reception unit 304.

The identification-code storage unit 306 is a memory that stores the terminal identification code (wireless base station) of the wireless base station 201. Note that the identification-code storage unit 306 may also retain the terminal identification code (wireless terminal station) or the terminal identification code (protector) received from the wireless terminal station 202. When there is no response from the wireless terminal station 202, the test response unit 301 reads out the terminal identification code (wireless base station) of the wireless base station 201 from the identification-code storage unit 306 and transmits the terminal identification code (wireless base station) to the exchange office 102 and the test desk 101.

The test-result accumulation unit 307 is a memory that accumulates a line test result received from the wireless terminal station 202. The line test result accumulated in the test-result accumulation unit 307 is read out by the test response unit 301 and transmitted to the exchange office 102 (S114 in FIG. 4).

Subsequently, the units of the wireless terminal station 202 are explained.

The antenna 401 converts a signal output by the transmission and reception unit 402 into a radio wave and transmits the radio wave to the wireless base station 201 and converts a radio wave received from the wireless base station 201 into a signal and outputs the signal to the transmission and reception unit 402.

The transmission and reception unit 402 has a function of transmitting and receiving signals to and from the wireless base station 201 via the antenna 401.

The test-signal communication unit 403 instructs, based on a test implementation request received from the wireless base station 201 via the transmission and reception unit 402, the test implementation unit 404 to implement a test. The test-signal communication unit 403 transmits a line test result accumulated in the test-result accumulation unit 405 to the wireless base station 201 via the transmission and reception unit 402. The test-signal communication unit 403 transmits the terminal identification code (wireless terminal station) stored in the identification-code storage unit 406 and the terminal identification code (protector) received from the protector 103 to the wireless base station 201 via the transmission and reception unit 402. Processing performed by the test-signal communication unit 403 corresponds to the test signal communication processing.

The test implementation unit 404 receives the instruction for the test implementation by the test-signal communication unit 403 and inverts the polarity of a line between the test implementation unit 404 and the protector 103. The test implementation unit 404 receives the terminal identification code (protector) and the line test result from the protector 103. Alternatively, the test implementation unit 404 inverts the polarity of the line and instructs the protector 103 to perform line opening. Processing performed by the test implementation unit 404 corresponds to the test implementation processing.

The test-result accumulation unit 405 is a memory that accumulates the line test result received from the protector 103. The line test result accumulated in the test-result accumulation unit 405 is transmitted to the wireless base station 201 together with the terminal identification code (protector) (S109 in FIG. 4).

The identification-code storage unit 406 is a memory that stores the terminal identification code (wireless terminal station) of the wireless terminal station 202 and the terminal identification code (protector) received from the protector 103. In this embodiment, when the terminal identification code (protector) and the line test result are not obtained from the protector 103, the terminal identification code (wireless terminal station) of the wireless terminal station 202 stored in the identification-code storage unit 406 is transmitted to the wireless base station 201.

In this way, in the line test system 100 according to this embodiment, the wireless base station 201 and the wireless terminal station 202 perform the function of performing the line test performed between the exchange office 702 and the protector 703 in the comparative example. Therefore, as in the line test system 700 in the comparative example not including a wireless section, the operator 111 of the test desk 101 can remotely operate the protector 103 and implement the line test.

[Specific Example of a Failed Section]

Subsequently, a specific example of a failed section in the line test system 100 according to this embodiment is explained.

(1) A line is disconnected between the exchange office 102 and the wireless base station 201

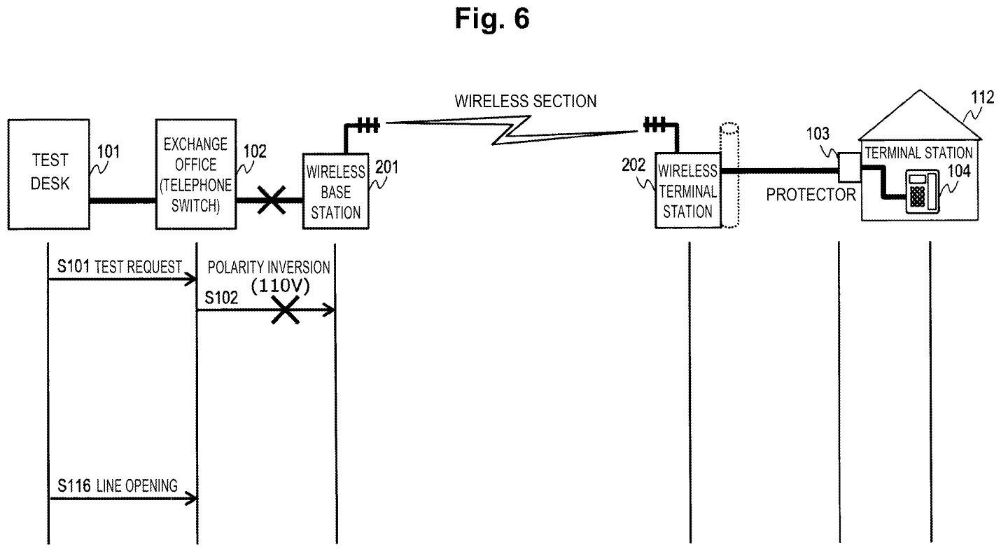

FIG. 6 shows an example of a case in which a line is disconnected between the exchange office 102 and the wireless base station 201. Note that FIG. 6 is based on the processing sequence explained with reference to FIG. 4. In processing steps denoted by the same signs as the signs in FIG. 4, the same processing as the processing in FIG. 4 is performed.

In step S102, the exchange office 102 receives a test request from the test desk 101 and inverts the polarity of a voltage of 110 V applied to the line.

However, in the example shown in FIG. 6, since the line between the exchange office 102 and the wireless base station 201 is disconnected, the exchange office 102 and the test desk 101 cannot obtain any response such as a terminal identification code from the wireless base station 201. Accordingly, since the operator 111 of the test desk 101 cannot obtain a response such as a terminal identification code, the operator 111 recognizes that a failure has occurred in the line between the exchange office 102 and the wireless base station 201. The operator 111 outputs the instruction for the line opening in step S116 to the exchange office 102 and informs the exchange office 102 that the operator 111 ends the line test.

In this way, the operator 111 can identify a failed section from the test desk 101 as in the related art and can instruct a maintenance person or the like to inspect the failed section.

(2) A line is disconnected between the wireless base station 201 and the wireless terminal station 202

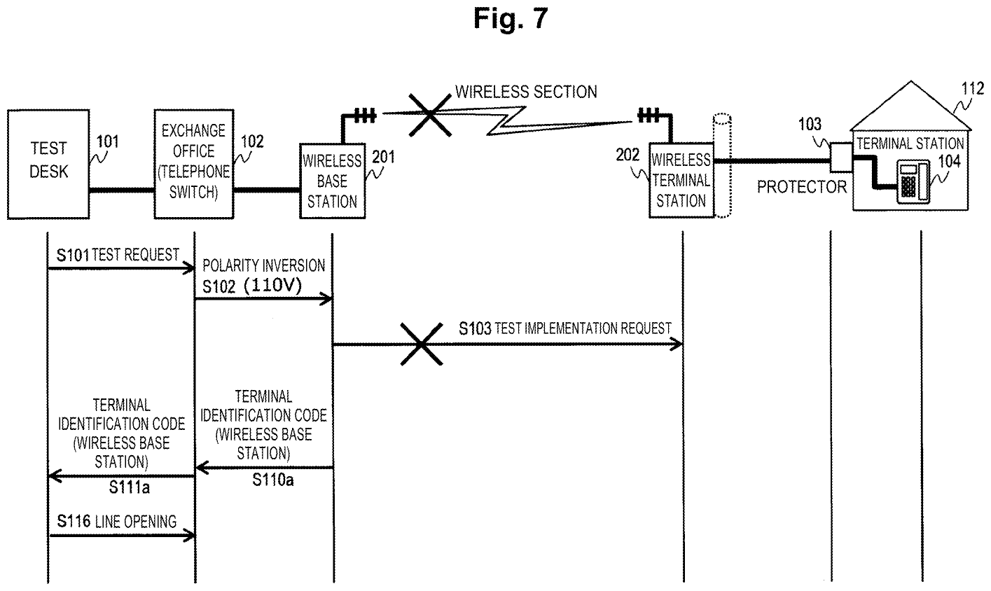

FIG. 7 shows an example of a case in which a line is disconnected in the wireless section between the wireless base station 201 and the wireless terminal station 202. Note that FIG. 7 is based on the processing sequence explained with reference to FIG. 4. In processing steps denoted by the same signs as the signs in FIG. 4, the same processing as the processing in FIG. 4 is performed.

In step S103, the wireless base station 201 detects that the polarity of a line input from the exchange office 102 is inverted and transmits a test implementation request to the wireless terminal station 202.

However, in the example shown in FIG. 7, since the line between the wireless base station 201 and the wireless terminal station 202 is disconnected, the wireless base station 201 cannot obtain any response such as a terminal identification code from the wireless terminal station 202. Accordingly, the wireless base station 201 transmits the terminal identification code (wireless base station) of the wireless base station 201 to the exchange office 102 (S110a). The exchange office 102 outputs the terminal identification code (wireless base station) received from the wireless base station 201 to the test desk 101 (S111a). Since only the terminal identification code (wireless base station) is displayed on the screen of the test desk 101, the operator 111 recognizes that a failure has occurred in the wireless section between the wireless base station 201 and the wireless terminal station 202. The operator 111 outputs the instruction for the line opening in step S116 to the exchange office 102 and informs the exchange office 102 that the operator 111 ends the line test.

In this way, the operator 111 can identify a failed section from the test desk 101 as in the related art and can instruct the maintenance person or the like to inspect the failed section.

(3) A line is disconnected between the wireless terminal station 202 and the protector 103

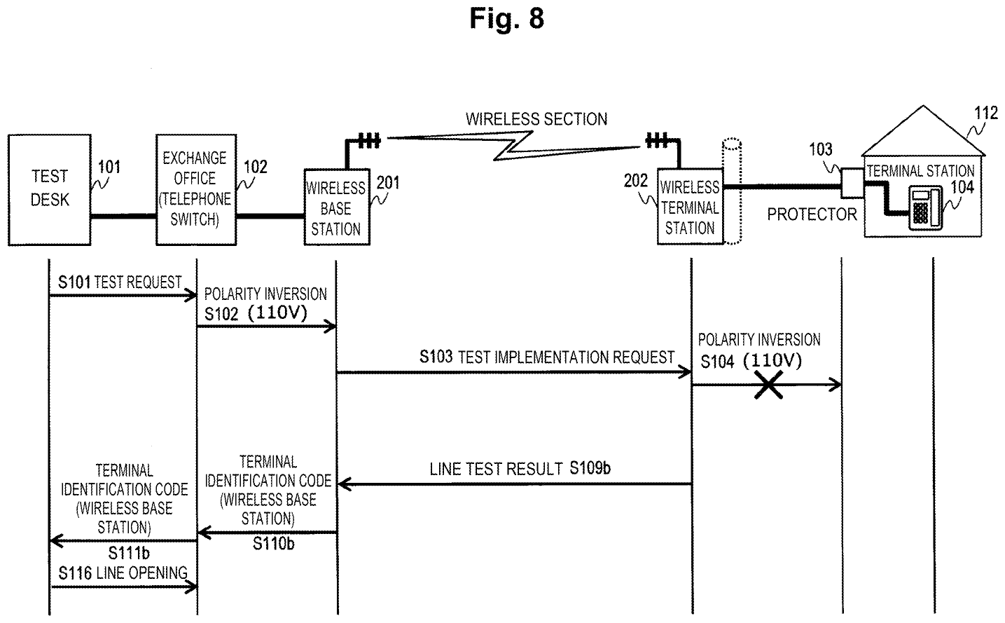

FIG. 8 shows an example of a case in which a line is disconnected between the wireless terminal station 202 and the protector 103. Note that FIG. 8 is based on the processing sequence explained with reference to FIG. 4. In processing steps denoted by the same signs as the signs in FIG. 4, the same processing as the processing in FIG. 4 is performed.

In step S104, the wireless terminal station 202 inverts, based on the test start request received from the wireless base station 201, the polarity of a voltage of 110 V applied to the line connected to the protector 103.

However, in the example shown in FIG. 8, since the line between the wireless terminal station 202 and the protector 103 is disconnected, the wireless terminal station 202 cannot obtain any response such as the terminal identification code (protector) from the protector 103. Accordingly, the wireless terminal station 202 transmits a dummy line test result including the terminal identification code (wireless terminal station) of the wireless terminal station 202 to the wireless base station 201 (S109b). The wireless base station 201 outputs the terminal identification code (wireless terminal station) received from the wireless terminal station 202 to the exchange office 102 (S110b). Further, the exchange office 102 outputs the terminal identification code (wireless terminal station) received from the wireless base station 201 to the test desk 101 (S111b). Since the terminal identification code (wireless terminal station) is displayed on the screen of the test desk 110, the operator 111 recognizes that a failure has occurred in the line between the wireless terminal station 202 and the protector 103. The operator 111 outputs the instruction for the line opening in step S116 to the exchange office 102 and informs the exchange office 102 that the operator 111 ends the line test.

In this way, the operator 111 can identify a failed section from the test desk 101 as in the related art and can instruct the maintenance person or the like to inspect the failed section.

### Application Example

In the line test sequence shown in FIG. 4, depending on a communication state in the wireless section, when a time is required until a test result is obtained, a problem is that the operator 111 of the test desk 101 does not know how long the operator 111 should wait for a line test result and feels uneasy. Therefore, in this application example, the wireless base station 201 returns the terminal identification code (wireless base station) to the test desk 101 after transmitting the test implementation request to the wireless terminal station 202, whereby the terminal identification code (wireless base station) is displayed on the screen of the test desk 101. Therefore, the operator 111 can recognize that the test request is normally received by the wireless base station 201 and measurement is being performed.

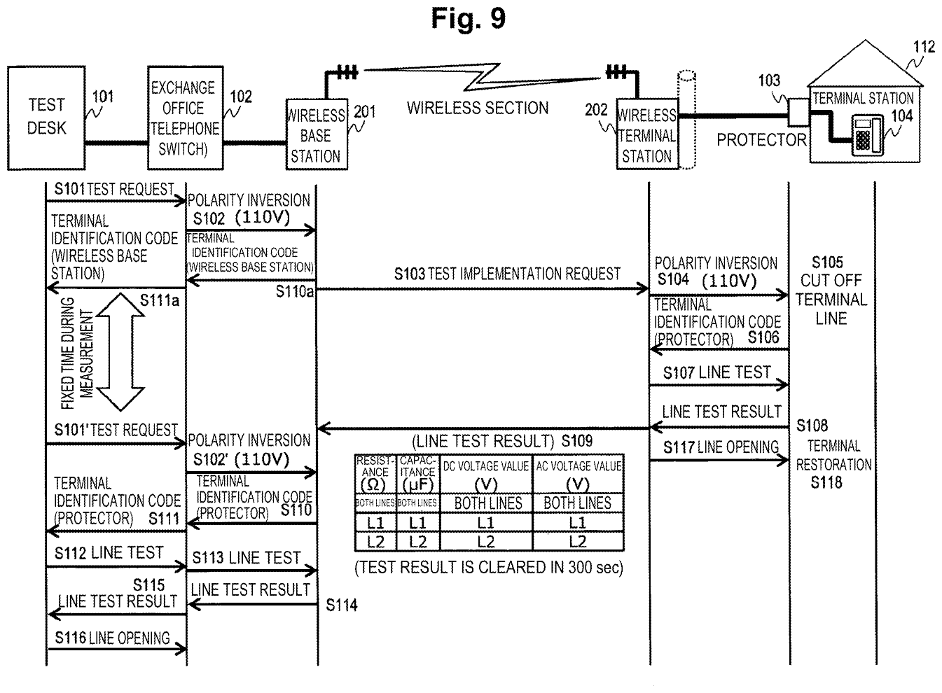

FIG. 9 shows an example of a line test sequence of the line test system 100 in the application example. Note that FIG. 9 is based on the processing sequence explained with reference to FIG. 4. In processing steps denoted by the same signs as the signs in FIG. 4, the same processing as the processing in FIG. 4 is performed. FIG. 9 is different from FIG. 4 in that, around the time of the transmission of the test implementation request to the wireless terminal station 202 in step S103, the wireless base station 201 returns the terminal identification code (wireless base station) to the exchange office 102 (S110a) and the terminal identification code (wireless base station) is output from the exchange office 102 to the test desk 101 and displayed on the screen of the test desk 101 (S111a). Consequently, the operator 111 recognizes that the test request is normally received by the wireless base station 201 and measurement is being performed. After a predetermined fixed time elapses, the operator 111 outputs a test request for the telephone line from the test desk 101 to the exchange office 102 again (S101′). The exchange office 102 receives the test request from the test desk 101 and inverts the polarity of the voltage of the 110 V applied to the line again (S102′). The wireless base station 201 that has received the test request outputs the terminal identification code (protector) included in the line test result received from the wireless terminal station 202 to the exchange office 102 (S110). Thereafter, the processing in steps S111 to S118 is executed in the same manner as in the case of FIG. 4. The line test result is displayed on the screen of the test desk 101. Note that the line test result may be cleared after a fixed time (for example, 300 sec) elapses.

In this way, the wireless base station 201 receiving the test request from the test desk 101 returns the terminal identification code (wireless base station) to the test desk 101 before the wireless base station 201 transmits the test implementation request to the wireless terminal station 202 and the line test result is obtained. Accordingly, the operator 111 can recognize that the test request is normally received by the wireless base station 201 and measurement is being performed. Consequently, even when a time lag occurs in the execution of the line test in the wireless section, it is possible to prevent the operator 111 from feeling uneasy.

While causing the operator 111 to recognize that measurement is being performed, the wireless terminal station 202 can implement the line test requested from the wireless base station 201 and transmits the line test result to the wireless base station 201. When the operator 111 implements a test request (polarity inversion) again within a fixed time (for example, 300 sec), the wireless base station 201 returns a line test result sent from the wireless terminal station 202 to the test desk 101 via the exchange office 102. The line test result between the wireless terminal station 202 and the protector 103 is displayed on the test desk 101. Note that, when a second test request received from the test desk 101 via the exchange office 102 is received after the fixed time (in the above example, 300 sec) from a first test request, the line test result is cleared.

When the wireless section is disconnected and the line test result does not arrive from the wireless terminal station 202, the wireless base station 201 transmits the terminal identification code (wireless base station) to the test desk 101. Note that, specifically, the wireless base station 201 determines whether the line test result arrives from the wireless terminal station 202 within a predetermined time.

Subsequently, a method of identifying a failed section in the line test system 100 in this application example is explained with reference to several examples.

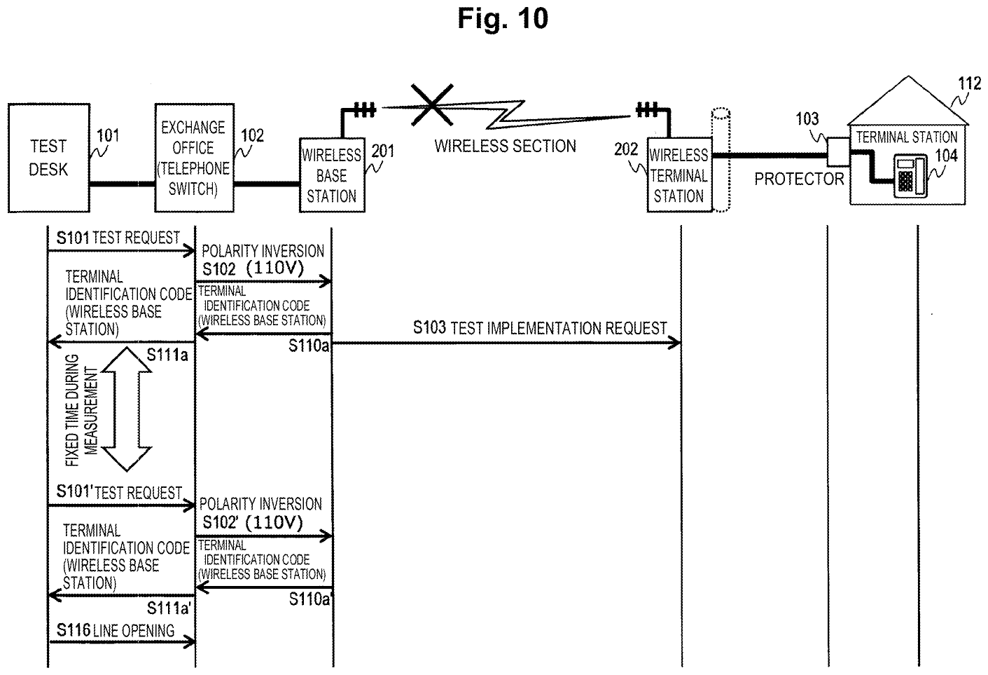

Like FIG. 7, FIG. 10 shows an example of a case in which the line is disconnected in the wireless section between the wireless base station 201 and the wireless terminal station 202. Note that FIG. 10 is based on the processing sequence explained with reference to FIG. 9. In processing steps denoted by the same signs as the signs in FIG. 9, the same processing as the processing in FIG. 9 is performed.

In FIG. 10, around the time of the transmission of the test implementation request to the wireless terminal station 202 in step S103, the wireless base station 201 returns the terminal identification code (wireless base station) to the exchange office 102 (S110a). The terminal identification code (wireless base station) is output from the exchange office 102 to the test desk 101 and displayed on the screen of the test desk 101 (S111a). After a predetermined fixed time elapses, the operator 111 outputs a test request for the telephone line from the test desk 101 to the exchange office 102 again (S101′). The exchange office 102 receives the test request from the test desk 101 and inverts the polarity of the voltage of 110 V applied to the line again (S102′).

However, in the example shown in FIG. 10, since the line between the wireless base station 201 and the wireless terminal station 202 is disconnected, the wireless base station 201 cannot obtain any response such as a terminal identification code from the wireless terminal station 202. The wireless base station 201 that has received this returns the terminal identification code (wireless base station) to the exchange office 102 again (S110a′). The terminal identification code (wireless base station) is output from the exchange office 102 to the test desk 101 and displayed on the screen of the test desk 101 (S111a′).

The terminal identification code (wireless base station) of the wireless base station 201 is displayed on the screen of the test desk 101 rather than the terminal identification code (protector) of the protector 103. Therefore, the operator 111 recognizes that a failure has occurred in the wireless section between the wireless base station 201 and the wireless terminal station 202. The operator 111 outputs the instruction for the line opening in step S116 to the exchange office 102 and informs the exchange office 102 that the operator 111 ends the line test.

In this way, the operator 111 can identify a failed section from the test desk 101 as in the related art and can instruct the maintenance person or the like to inspect the failed section.

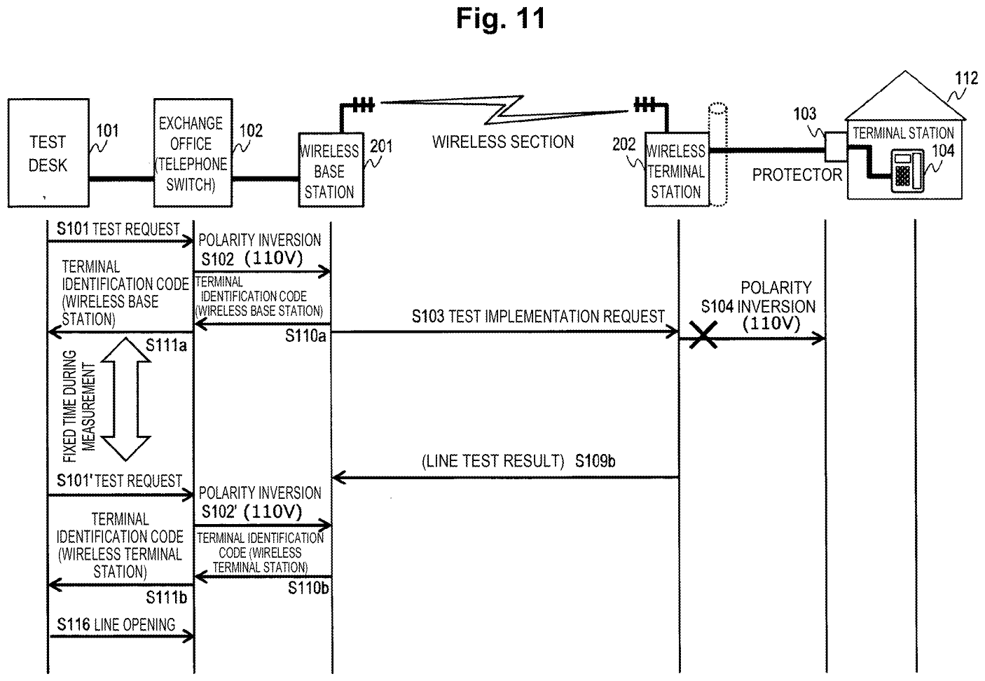

Like FIG. 8, FIG. 11 shows an example of a case in which the line between the wireless terminal station 202 and the protector 103 is disconnected. Note that FIG. 11 is based on the processing sequence explained with reference to FIG. 9. In processing steps denoted by the same signs as the signs in FIG. 9, the same processing as the processing in FIG. 9 is performed.

In FIG. 11, around the time of the transmission of the test implementation request to the wireless terminal station 202 in step S103, the wireless base station 201 returns the terminal identification code (wireless base station) to the exchange office 102 (S110a). The terminal identification code (wireless base station) is output from the exchange office 102 to the test desk 101 and displayed on the screen of the test desk 101 (S111a). The wireless terminal station 202 inverts, based on the test implementation request received from the wireless base station 201 (S103), the polarity of the voltage of 110 V applied to the line connected to the protector 103 (S104).

However, in the example shown in FIG. 11, since the line between the wireless terminal station 202 and the protector 103 is disconnected, the wireless terminal station 202 cannot obtain any response such as the terminal identification code (protector) from the protector 103. Accordingly, the wireless terminal station 202 transmits a dummy line test result including the terminal identification code (wireless terminal station) of the wireless terminal station 202 to the wireless base station 201 (S109b).

After a predetermined fixed time elapses, the operator 111 outputs a test request for the telephone line from the test desk 101 to the exchange office 102 again (S101′). The exchange office 102 receives the test request from the test desk 101 and inverts the polarity of the voltage of 110 V applied to the line again (S102′). The wireless base station 201 that has received the test request outputs the terminal identification code (wireless terminal station) received from the wireless terminal station 202 to the exchange office 102 (S110b). Further, the exchange office 102 outputs the terminal identification code (wireless terminal station) received from the wireless base station 201 to the test desk 101 (S111b). The terminal identification code (wireless terminal station) is displayed on the screen of the test desk 101. Therefore, the operator 111 recognizes that a failure has occurred in the line between the wireless terminal station 202 and the protector 103. The operator 111 outputs the instruction for the line opening in step S116 to the exchange office 102 and informs the exchange office 102 that the operator 111 ends the line test.

In this way, the operator 111 can identify a failed section from the test desk 101 as in the related art and can instruct the maintenance person or the like to inspect the failed section.

[Processing for Identifying a Failed Section]

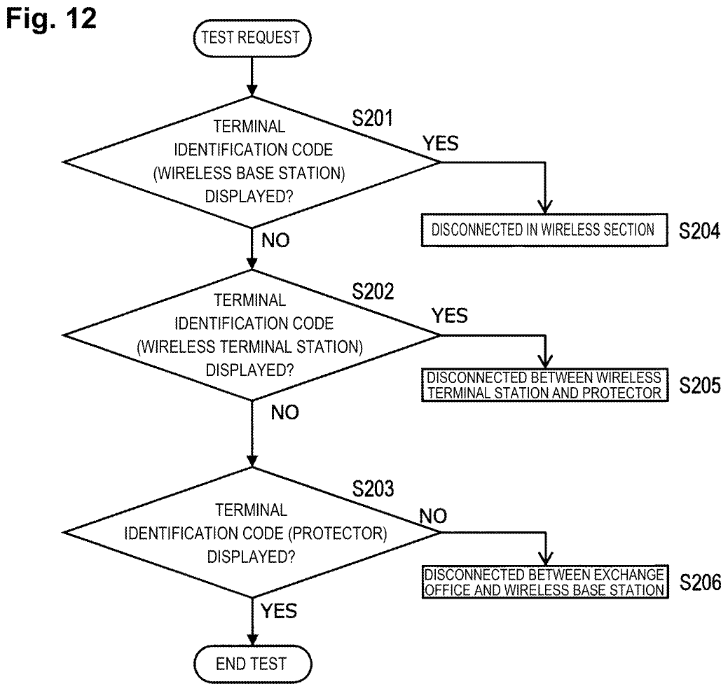

FIG. 12 shows a flow of processing for identifying a failed section with the test desk 101 in the line test system 100 according to the embodiments explained above.

In step S201, the line test system 100 discriminates whether the terminal identification code (wireless base station) is displayed on the screen of the test desk 101 and, when the terminal identification code (wireless base station) is displayed, proceeds to processing in step S204 and, when the terminal identification code (wireless base station) is not displayed, proceeds to processing in step S202.

In step S202, the line test system 100 discriminates whether the terminal identification code (wireless terminal station) is displayed on the screen of the test desk 101 and, when the terminal identification code (wireless terminal station) is displayed, proceeds to the processing in step S204 and, when the terminal identification code (wireless terminal station) is not displayed, proceeds to processing in step S203.

In step S203, the line test system 100 discriminates whether the terminal identification code (protector) is displayed on the screen of the test desk 101 and, when the terminal identification code (protector) is displayed, normally ends the processing and, when the terminal identification code (protector) is not displayed, proceeds to processing in step S206.

In step S204, the operator 111 of the test desk 101 determines that the line is disconnected in the wireless section.

In step S205, the operator 111 of the test desk 101 determines that the line between the wireless terminal station 202 and the protector 103 is disconnected.

In step S206, the operator 111 of the test desk 101 determines that the line between the exchange office 102 and the wireless base station 201 is disconnected.

In this way, the line test system 100 according to this embodiment can identify a failed section. Note that the processing for identifying a failed section shown in FIG. 12 may be executed by software of the test desk 101 rather than the operator 111. When a failed section is present, the software may instruct, from the test desk 101, a portable terminal of the maintenance person to inspect the failed section.

As explained above in the embodiments, the line test system 100 makes it possible to transmit and receive, with the wireless base station 201 and the wireless terminal station 202 forming the wireless section, information such as a line test request, a line test result, and a terminal identification code between the exchange office 102 and the protector 103. Therefore, the operator 111 can remotely operate the protector 103 from the test desk 101 and implement a line test as in the related art. A terminal identification code returned to the test desk 101 is different depending on a failed section. Therefore, the operator 111 can easily identify a failed section by discriminating a terminal identification code of which of the protector 103, the wireless terminal station 202, and the wireless base station 201 a terminal identification code displayed on the test desk 101 is.

The wireless base station 201 receives a test request from the test desk 101 and transmits a test implementation request to the wireless terminal station 202 and transmits the terminal identification code (wireless base station) of the wireless base station 201 to the test desk 101. Accordingly, the operator 111 of the test desk 101 can recognize that the test request is received by the wireless base station 201 and measurement is being performed. Consequently, even when a time lag occurs in the execution of the line test in the wireless section, it is possible to prevent the operator 111 from feeling uneasy.

In this way, the line test system and the line test method according to the present invention can implement, in a telephone line including a wireless section, a line test from a remote place with the same method as the conventional method for the telephone line not including a wireless section and can easily identify a failed section.

### REFERENCE SIGNS LIST

100, 700, 700a Line test system
101, 701 Test desk
102, 702 Exchange office
201, 801 Wireless base station
202, 802 Wireless terminal station
103, 703 Protector
104, 704 Terminal station
111, 711 Operator
112, 712 Subscriber home
301 Test response unit
302 Test request unit
303, 403 Test-signal communication unit
304, 402 Transmission and reception unit
305, 401 Antenna
306, 406 Identification-code storage unit
307, 405 Test-result accumulation unit
404 Test implementation unit

1. A line test system that performs a test of a telephone line that includes a wireless section formed by a wireless base station device and a wireless terminal station device and connects a host station and a subscriber home,
the wireless base station device including:
a test request unit that, upon receipt of a line test request from the host station side, transmits an implementation request for a line test to the wireless terminal station device; and
a test response unit that transmits at least one of a terminal identification code returned from the wireless terminal station device and a terminal identification code and a line test result of the wireless base station device to the host station side,
the wireless terminal station device including:
a test implementation unit that receives the implementation request for the line test from the wireless base station device, executes the line test between the wireless terminal station device and the subscriber home, and acquires the line test result; and
a test-signal communication unit that transmits at least one of a terminal identification code returned from a device on the subscriber home side and a terminal identification code and a line test result of the wireless terminal station device to the wireless base station device.

2. The line test system according to claim 1, wherein, when the terminal identification code is not returned from the wireless terminal station device, the test response unit of the wireless base station device transmits the terminal identification code of the wireless base station device to the host station side.

3. The line test system according to claim 1, wherein, when the terminal identification code is not returned from the device on the subscriber home side, the test-signal communication unit of the wireless terminal station device transmits the terminal identification code of the wireless terminal station device to the wireless base station device.

4. The line test system according to claim 1, wherein the test response unit of the wireless base station device transmits, when the test request unit receives the line test request from the host station side, the terminal identification code of the wireless base station device to the host station side and transmits, when the test request unit receives the line test request from the host station side again after a predetermined fixed time elapses, at least one of the terminal identification code returned from the wireless terminal station device and the terminal identification code and the line test result of the wireless base station device to the host station side.

5. A line test method for performing a test of a telephone line that includes a wireless section formed by a wireless base station device and a wireless terminal station device and connects a host station and a subscriber home,
the wireless base station device executing:
test request processing for, upon receipt of a line test request from the host station side, transmitting an implementation request for a line test to the wireless terminal station device; and
test response processing for transmitting at least one of a terminal identification code returned from the wireless terminal station device and a terminal identification code and a line test result of the wireless base station device to the host station side,
the wireless terminal station device executing:
test implementation processing for receiving the implementation request for the line test from the wireless base station device, executing the line test between the wireless terminal station device and the subscriber home, and acquiring the line test result; and
test-signal communication processing for transmitting at least one of a terminal identification code returned from a device on the subscriber home side and a terminal identification code and a line test result of the wireless terminal station device to the wireless base station device.

6. The line test method according to claim 5, wherein, in the test response processing of the wireless base station device, when the terminal identification code is not returned from the wireless terminal station device, the terminal identification code of the wireless base station device is transmitted to the host station side.

7. The line test method according to claim 5, wherein, in the test signal communication processing of the wireless terminal station device, when the terminal identification code is not returned from the device on the subscriber home side, the terminal identification code of the wireless terminal station device is transmitted to the wireless base station device.

8. The line test method according to claim 5, wherein, in the test response processing of the wireless base station device, when the line test request is received from the host station side by the test request processing, the terminal identification code of the wireless base station device is transmitted to the host station side and, when the line test request is received from the host station side again by the test request processing after a predetermined fixed time elapses, at least one of the terminal identification code returned from the wireless terminal station device and the terminal identification code and the line test result of the wireless base station device is transmitted to the host station side.
